(19) United States
(12) Patent Application Publication
(10) Pub. No.: US 2002/0147860 A1
(43) Pub. Date: Oct. 10, 2002

(54) Method, apparatus, and program for generating Java full thread dumps from a remote JVM

(75) Inventor: Kevin Gary Tapperson, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/826,749

(22) Filed: Apr. 5, 2001

(51) Int. Cl. G06F 9/46; G06F 15/163; G06F 17/00; G06F 9/00; G06F 9/54

(52) U.S. Cl. 709/330

(57) ABSTRACT

A virtual windows console is provided for a server Java Virtual Machine. When a user enters a full thread dump command at a remote Java Virtual Machine, the dump command is sent to the server Java Virtual Machine via remote method invocation protocol in the same manner all other commands are sent to the server Java Virtual Machine. The server Java Virtual Machine then passes a key sequence to the virtual windows console and the virtual windows console sends the key sequence back to the server Java Virtual Machine that generates the full thread dump. The full thread dump is then passed to a thread dump server task through a hook in the server Java Virtual Machine. The thread dump server task then passes the full thread dump back to the client Java Virtual Machine via remote method invocation protocol in the same manner all other results are returned from the server Java Virtual Machine.

### BACKGROUND OF THE INVENTION

1. Technical Field

The present invention relates to data processing systems and, in particular, to generating full thread dumps in a distributed data processing system. Still more particularly, the present invention provides a method, apparatus, and program for generating full thread dumps in a server Java Virtual Machine from a remote Java Virtual Machine.

2. Description of Related Art:

Java is a programming language designed to generate applications that can run on all hardware platforms without modification. Java was modeled after C++, and Java programs can be called from within hypertext markup language (HTML) documents or launched stand alone. The source code of a Java program is compiled into an intermediate language called “bytecode,” which cannot run by itself. The bytecode must be converted (interpreted) into machine code at runtime. When running a Java application, a Java interpreter (Java Virtual Machine) is invoked. The Java Virtual Machine (JVM) translates the bytecode into machine code and runs it. As a result, Java programs are not dependent on any specific hardware and will run in any computer with the Java Virtual Machine software.

Remote Method Invocation (RMI) is a remote procedure call (RPC), which allows Java objects (software components) stored in a network to be run remotely. In the Java distributed object model, a remote object is one whose methods can be invoked from another JVM, potentially on a different host.

When a JVM is started from a console application, the JVM provides a mechanism to generate a full thread dump, which returns the current status of each Java thread in the process. The full thread dump of a JVM is a very useful tool for debugging Java application code, as well as the JVM itself. Normally, a full thread dump can be generated by pressing a sequence of keys, such as a Control-Break (Ctrl-Break) key sequence, in the console window in which the Java application is running. However, if the Java application does not have a console window, the user cannot issue a key sequence to generate a full thread dump, as is the case with remote objects using the RMI protocol.

Thus, it would be advantageous to provide a mechanism for generating a full thread dump from a remote Java Virtual Machine.

### SUMMARY OF THE INVENTION

The present invention provides a mechanism for performing a full thread dump at a remote JVM. The present invention provides a virtual windows console for the server JVM. When a user enters a full thread dump command, the dump command is sent to the server JVM via RMI in the same manner all other commands are sent to the server JVM. The server JVM then passes a key sequence to the virtual windows console and the virtual windows console sends the key sequence back to the server JVM that generates the full thread dump. The full thread dump is then passed to a thread dump server task through a hook in the server JVM. The thread dump server task then passes the full thread dump back to the client JVM via RMI in the same manner all other results are returned from the server JVM.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are diagrams depicting a full thread dump in a prior art Java Virtual Machine environment;

FIG. 5 is a diagram illustrating the generation of a full thread dump at a server JVM from a remote JVM in accordance with a preferred embodiment of the present invention;

FIG. 6 is a flowchart of the operation of a client Java Virtual Machine in accordance with a preferred embodiment of the present invention; and

FIG. 7 is a flowchart of the operation of a server Java Virtual Machine in accordance with a preferred embodiment of the present invention.

### DETAILED DESCRIPTION OF THE PREFERRED EMBODIMENT

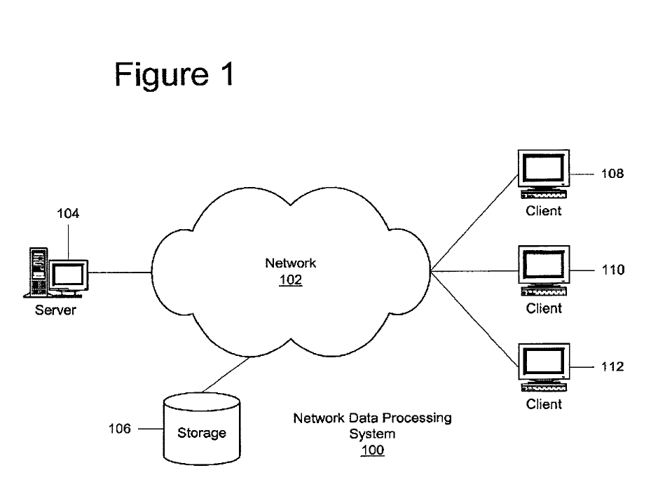

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

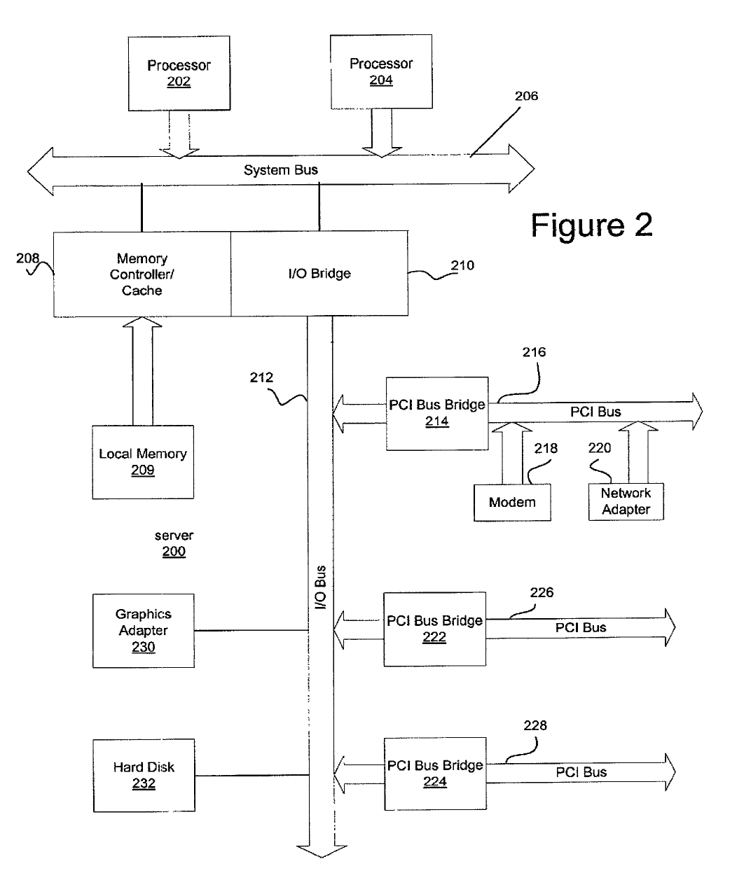

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, New York, running the Advanced Interactive Executive (AIX) operating system.

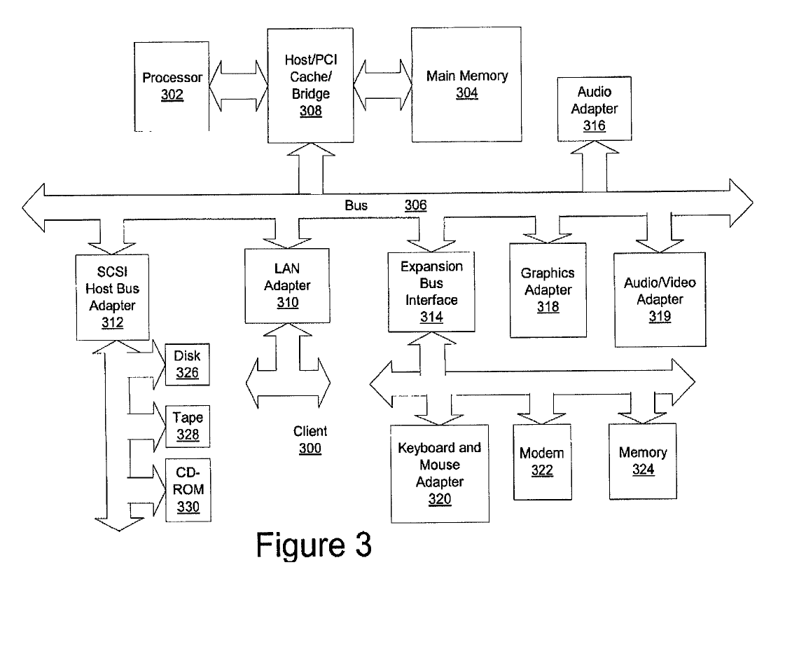

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

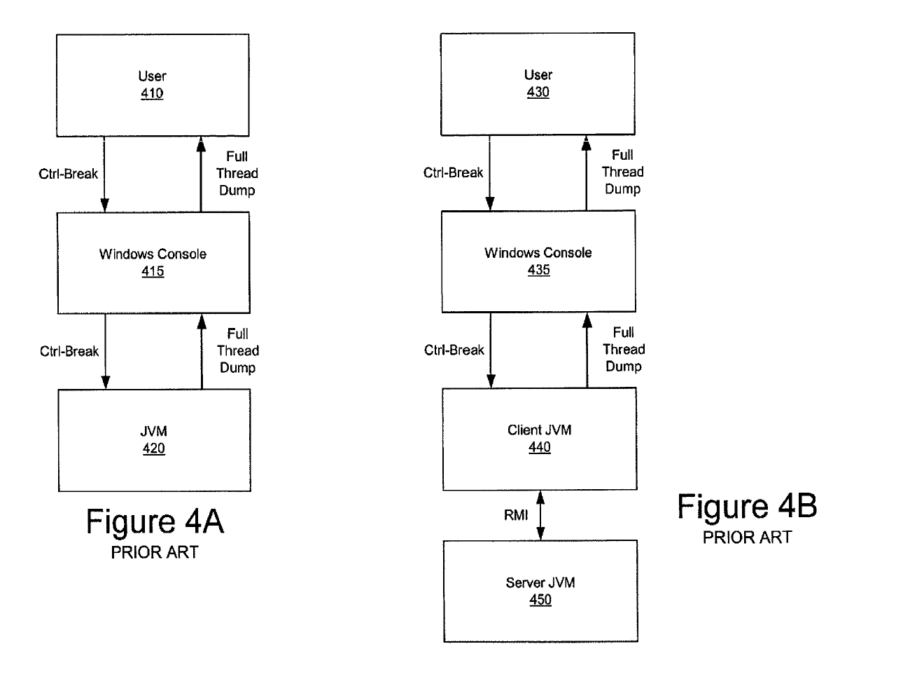

With reference now to FIGS. 4A and 4B, diagrams are shown depicting a full thread dump in a prior art Java Virtual Machine environment. Particularly with respect to FIG. 4A, a user 410 issues a key sequence, such as Ctrl-Break, to windows console 415 to generate a full thread dump. The windows console passes the key sequence to Java Virtual Machine (JVM) 420. The JVM generates a full thread dump and returns the full thread dump to windows console 415. The windows console then passes the full thread dump to user 410.

Turning now to FIG. 4B, user 430 issues a key sequence, such as Ctrl-Break, to windows console 435 to generate a full thread dump. The windows console passes the key sequence to client JVM 440. The client JVM generates a full thread dump and returns the full thread dump to windows console 435. The windows console then passes the full thread dump to user 430.

Client JVM 440 may pass user commands to server JVM 450 through the Remote Method Invocation (RMI) protocol. However, the system shown in FIG. 4B does not provide a mechanism for generating a full thread dump at the server JVM from the client JVM.

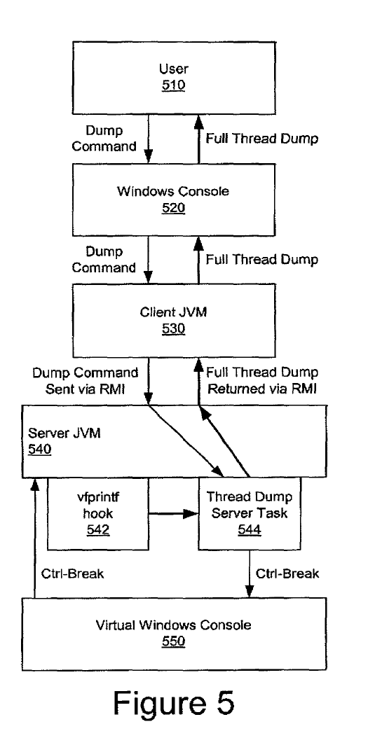

With reference now to FIG. 5, a diagram illustrating the generation of a full thread dump at a server JVM from a remote JVM is shown in accordance with a preferred embodiment of the present invention. User 510 issues a dump command to windows console 520 to generate a full thread dump at server JVM 540. The windows console passes the dump command to client JVM 530. The client JVM then sends the dump command to the server JVM via the RMI protocol in the same manner other commands are sent to the server JVM.

The server JVM responds to the dump command by invoking thread dump server task 544. The thread dump server task begins capturing all output from the vfprintf hook 542 that is destined for the stderr handle. A hook is a set of instructions that provides breakpoints for future expansion. Hooks may be changed to call some outside routine or function or may be places where additional processing is added. Stderr is a standard file handle to which applications may send error messages. Likewise, there is a “stdout” file handle that is used for normal output by applications. When the JVM generates a full thread dump, it sends the full thread dump to the stderr file handle. Usually, the stderr file handle displays text on the screen, i.e. the windows console. In accordance with a preferred embodiment of the present invention, all output is captured to the stderr file handle and forwarded to the thread dump server task.

In response to receiving a thread dump command from the server JVM, the thread dump server task issues a key sequence to virtual windows console 550 at the server. The virtual windows console then passes the key sequence to server JVM 540 as if it received a full thread dump key sequence from a user. The server JVM then generates a full thread dump.

The full thread dump is then passed to vfprintf hook 542, which returns the data to thread dump server task 544. Once all of the full thread dump has been captured, the thread dump server task then forwards the full thread dump back to the client JVM via RMI, in the same manner all other results are returned from the server JVM. The client JVM then returns the full thread dump to windows console 520. The windows console then, in turn, returns the full thread dump to user 510.

Using this mechanism, the user may enter a dump command from a console at a remote JVM and receive a full thread dump from the server JVM. The dump command may then be passed to the server JVM using the normal communication process between the client JVM and the server JVM. Likewise, the resulting full thread dump can be returned to the client JVM using the normal communication process between the client JVM and the server JVM. In accordance with a preferred embodiment of the present invention, the communication mechanism used here is RMI; however, other communication mechanisms may be used within the scope of the invention.

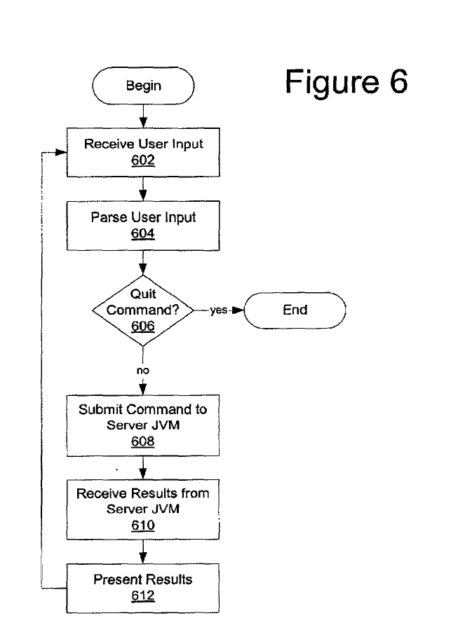

With. reference to FIG. 6, a flowchart of the operation. of a client Java Virtual Machine is shown in accordance with a preferred embodiment of the present invention. The process begins and receives user input (step 602). The process parses the user input (step 604) and a determination is made as to whether the input is a quit command (step 606). If the input is a quit command, the process ends.

If the input is not a quit command in step 606, the process submits the command to a server JVM (step 608), receives results from the server JVM (step 610), and presents the results (step 612). Thereafter, the process returns to step 602 to receive user input.

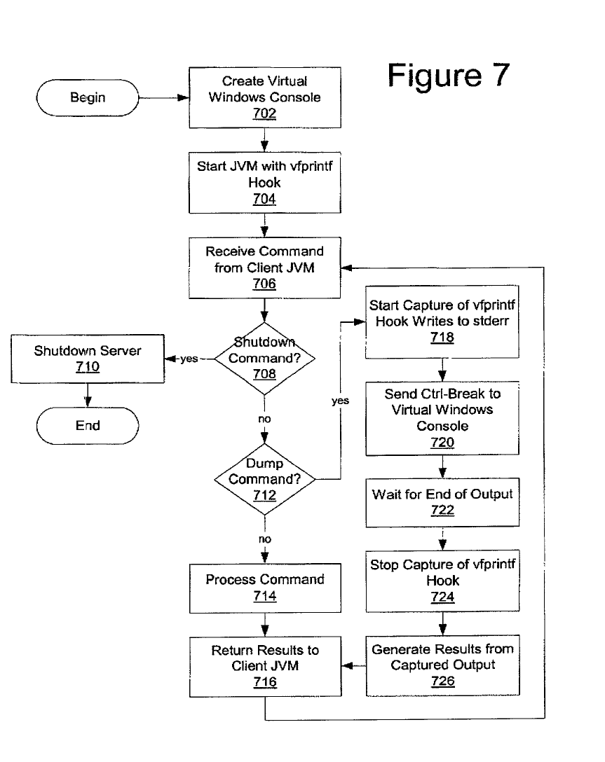

With reference now to FIG. 7, a flowchart of the operation of a server Java Virtual Machine is illustrated in accordance with a preferred embodiment of the present invention. The process begins and creates a virtual windows console (step 702). Next, the process starts the JVM with a vfprintf hook (step 704) and receives a command from the client JVM (step 706). A determination is made as to whether the command is a shutdown command (step 708). If the command is a shutdown command, the process performs a shutdown of the server JVM (step 710) and ends.

If the command is not a shutdown command in step 708, a determination is made as to whether the command is a dump command. If the command is not a dump command, the process processes the command (step 714), returns the results to the client JVM (step 716), and returns to step 706 to receive a command from the client JVM.

If the command is a dump command in step 712, the process starts capture of vfprintf hook writes to stderr (step 718), sends a Ctrl-Break to the virtual windows console (step 720), and waits for end of output (step 722). Stderr is a standard file handle to which applications may send error messages. Likewise, there is a “stdout” file handle that is used for normal output by applications. When the JVM generates a full thread dump, it sends the full thread dump to the stderr file handle. Usually, the stderr file handle displays text on the screen, i.e. the windows console. In accordance with a preferred embodiment of the present invention, all output is captured to the stderr file handle and forwarded to the thread dump server task. Thereafter, the process stops capture of the vfprintf hook (step 724), generates results from captured output (step 726), and proceeds to step 716 to return the results to the client JVM. Thereafter, the process returns to step 706 to receive a command from the client JVM.

Thus, the present invention solves the disadvantages of the prior art by providing a mechanism for performing a full thread dump at a remote JVM. The present invention provides a virtual windows console for the server JVM. When a user enters a full thread dump command, the dump command is sent to the server JVM via RMI in the same manner all other commands are sent to the server JVM. The server JVM then passes a key sequence to the virtual windows console and the virtual windows console sends the key sequence back to the server JVM that generates the full thread dump. The full thread dump is then passed to a thread dump server task through a hook in the server JVM. The thread dump server task then passes the full thread dump back to the client JVM via RMI in the same manner all other results are returned from the server JVM. Therefore, a user may perform a full thread dump for a server JVM at a remote JVM and debug the Java application code running on the server, as well as the server JVM itself.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for generating a full thread dump at a server virtual machine, comprising:
receiving a server dump request from a client virtual machine;
invoking a task to issue a thread dump request;
generating a thread dump in response to the thread dump request; and
passing the thread dump to the client virtual machine.

2. The method of claim 1, wherein the step of receiving a server dump request comprises receiving the server dump request using remote method invocation protocol.

3. The method of claim 1, wherein the step of passing the full thread dump to the client virtual machine comprises:
capturing the thread dump using a hook; and
passing the captured thread dump to the server task.

4. The method of claim 3, wherein the hook is vfprintf.

5. The method of claim 3, wherein the step of capturing the thread dump using a hook comprises reading the captured thread dump from a standard file handle for error messages.

6. The method of claim 3, wherein the standard file handle for error messages is stderr.

7. The method of claim 3, wherein the step of passing the thread dump to the client virtual machine further comprises:
sending the thread dump from the server task to the client virtual machine using remote method invocation protocol.

8. The method of claim 1, wherein the step of passing the thread dump to the client virtual machine comprises sending the thread dump using remote method invocation protocol.

9. A method for generating a server virtual machine full thread dump at a remote virtual machine, comprising:
sending a server thread dump request to the server virtual machine;
receiving a thread dump from the server virtual machine; and
presenting the thread dump.

10. The method of claim 9, further comprising:
debugging the server virtual machine at the remote virtual machine using the thread dump.

11. An apparatus for generating a thread dump at a server virtual machine, comprising:
receipt means for receiving a server dump request from a client virtual machine;
invocation means for invoking a task to issue a thread dump request;
generation means for generating a thread dump in response to the thread dump request; and
communication means for passing the thread dump to the client virtual machine.

12. The apparatus of claim 11, wherein the receipt means comprises means for receiving the server dump request using remote method invocation protocol.

13. The apparatus of claim 11, wherein the communication means comprises:
capture means for capturing the thread dump using a hook; and
passing means for passing the captured thread dump to the server task.

14. The apparatus of claim 13, wherein the hook is vfprintf.

15. The apparatus of claim 13, wherein the capture means comprises means for reading the captured thread dump from a standard file handle for error messages.

16. The apparatus of claim 13, wherein the standard file handle for error messages is stderr.

17. The apparatus of claim 13, wherein the passing means further comprises:
means for sending the thread dump from the server task to the client virtual machine using remote method invocation protocol.

18. The apparatus of claim 11, wherein the communication means comprises means for sending the full thread dump using remote method invocation protocol.

19. An apparatus for generating a server virtual machine thread dump at a remote virtual machine, comprising:
sending means for sending a server thread dump request to the server virtual machine;
receipt means for receiving a thread dump from the server virtual machine; and
presentation means for presenting the thread dump at the remote virtual machine.

20. A computer program product, in a computer readable medium, For generating a full thread dump at a server virtual machine, comprising:
instructions for receiving a server dump request from a client virtual machine;
instructions for invoking a task to issue a thread dump request;
instructions for generating a thread dump in response to the thread dump request; and
instructions for passing the thread dump to the client virtual machine.

21. A computer program product, in a computer readable medium, for generating a server virtual machine full thread dump at a remote virtual machine, comprising:
instructions for sending a server thread dump request to the server virtual machine;
instructions for receiving a thread dump from the server virtual machine; and
instructions for presenting the thread dump.
